(19) United States
(12) Patent Application Publication
(10) Pub. No.: US 2014/0287212 A1
(43) Pub. Date: Sep. 25, 2014

(54) BIOPOLYESTER COMPOSITIONS WITH GOOD TRANSPARENCY AND SLIDING PROPERTIES

(71) Applicant: POLYONE CORPORATION, Avon Lake, OH (US)

(72) Inventors: Estelle Boullonnois, L'Isle-Adam (FR); Jerome Waeler, Saint Martin le Noeud (FR)

(73) Assignee: POLYONE CORPORATION, Avon Lake, OH (US)

(21) Appl. No.: 14/359,525

(22) PCT Filed: Nov. 27, 2012
(86) PCT No.: PCT/US12/66682

§ 371 Date: May 20, 2014

Related U.S. Application Data
(60) Provisional application No. 61/564,686, filed on Nov. 29, 2011.

(51) Int. Cl. C08K 3/34; C08K 5/092; C08K 5/20

(52) U.S. Cl. CPC C08K 3/34; C08K 5/20; C08K 5/092
USPC 428/216; 524/311; 524/230; 524/227; 524/275; 524/312; 523/122; 428/339

(57) ABSTRACT

A composition has been made for biopolyester films, preferably polylactic acid (PLA) films, having a low coefficient of friction for improved sliding properties, while maintaining a low haze value for good transparency. The composition, made from a masterbatch of specific additives, produces a film that achieves a haze of two percent or less (measured by ASTM D1003) and a dynamic coefficient of friction of 0.35 or less (measured by ASTM D1894-01).

### CLAIM OF PRIORITY

This application claims priority from U.S. Provisional Patent Application Ser. No. 61/564,686 bearing Attorney Docket Number 12011013 and filed on Nov. 29, 2011, which is incorporated by reference.

### FIELD OF THE INVENTION

This invention relates to compositions for polylactic acid films or sheet having good transparency and good sliding properties because of a low coefficient of friction and masterbatches useful for the production of these films or sheet.

### BACKGROUND OF THE INVENTION

Polylactic acid, also known as polylactide or PLA, is a thermoplastic resin of biologically sustainable origins that is being explored as a replacement for petrochemically originated resins in many applications. Specifically, in the plastics packaging industry there is a significant effort underway to use biologically-derived and sustainable sources of thermoplastic resins, preferably those which also degrade or are compostable. PLA is particularly attractive for its potential use in film applications for retail packaging, where the eco-friendly benefits of PLA's reliance on renewable resources and compost-ability are attractive to consumers.

PLA, however, differs significantly from traditional plastics used in the packaging industry, such as polyethylene, polypropylene, polystyrene, polyvinyl chloride (PVC) and PET. Due to the chemistry of PLA, the additives used in traditional petroleum-based polymer compounds do not have the same effect, and are even sometimes are detrimental to, the sliding and haze properties of a desired film.

Additionally, PLA must have the required properties for processing the film on the same large scale, high-speed packaging equipment designed for petroleum-based polymers, including equipment used to produce cast films or sheets, biaxially-oriented films and blown films. Particularly, coefficients of friction (COF) as measured dynamically need to be lower in order to process more easily the films or sheets, to be more desirable for use in packaging film, because the film or sheet is less “tacky” when in contact with moving rollers or other film or sheet on a processing line or during the use of the finally shaped article.

### SUMMARY OF THE INVENTION

In one aspect, the invention what the industry needs is a biopolyester film or sheet, preferably a PLA film or sheet, that has the desirable properties of a low coefficient of friction (COF) measured dynamically, while still maintaining good transparency for the wide application of such films and sheets in packaging of electronics, food, medical products, pharmaceuticals, chemical products; label films; and technical films.

One embodiment of the present invention is a composition for biopolyester films or sheets having low Dynamic COF and low haze properties, and that includes (a) biopolyester(s); (b) inorganic antiblock additive; (c) slip additive; and (d) optionally, other additives wherein the inorganic antiblock is sodium calcium aluminosilicate hydrate, wherein the slip additive is selected from the group consisting of polyol partial ester; fully hydrogenated soybean oil; ester with pentaerythritol; N,N′-Ethylene Bis(Stearamide); and combinations thereof, and wherein the composition when in the form of a 30 micron film having a core layer of about 20 microns thickness and two skin layers each of about 5 microns thickness has both a Dynamic COF of less than 0.35 when measured according to ASTM D1894-01, preferably less than 0.2, and a haze value of less than two percent when measured according to ASTM D1003.

Another embodiment of the present invention is a film or sheet formed from the biopolyester composition described immediately above. The film or sheet may have a single layer from 5 μm to 1 mm or multiple layers. In multilayer films, each individual layer may comprise a different combination of ingredients. Another embodiment of the present invention is a multi-layer film with at least a skin layer of biopolyester. The skin layer can be between about 0.5 microns to about 500 μm, and preferably about 1.0 micron to about 50 microns.

Preferable embodiments of the invention are biopolyester thin films having a total thickness of about 30 μm with skin layers between 1 μm and 5 μm haze of two percent or less according to the ASTM D1003 method and a Dynamic COF of 0.35 or less according to the ASTM D1894-01 method, preferably less than 0.2.

Another preferred embodiment of the invention is a biaxially-oriented film. “Biaxially oriented” means that the film is stretched transversely in two directions during processing. Biaxial stretching of films can be effective for creating films with superior strength, flatness, thermal shrinkage, and gas permeability.

For purposes of this invention, a low Dynamic COF is acceptably less than 0.35, preferably less than 0.20.

For purposes of this invention, a low haze value is acceptably less than 2% when measured according to ASTM D1003 upon a film having a thickness of about 30 microns. Those persons having ordinary skill in the art, without undue experimentation, will understand that haze inherently increases with increasing thickness. Therefore, this identification of haze in relation to film thickness gives to those persons a guidepost for amount of acceptable haze, regardless of the thickness of the film.

In a further aspect, the invention provides masterbatches or combinations of masterbatches containing (a) inorganic antiblock wherein the inorganic antiblock is sodium calcium aluminosilicate hydrate in a polymer carrier, preferably in biopolyester carrier and (b) slip additive wherein the slip additive is selected from the group consisting of polyol partial ester; fully hydrogenated soybean oil; ester with pentaerythritol; N,N′-Ethylene Bis(Stearamide); and combinations thereof in a polymer carrier, preferably in biopolyester carrier.

In a further aspect, the invention provides a method for producing biopolyester compositions comprising the step of mixing the biopolyester masterbatches composition of the present invention with biopolyester resin.

In a further aspect, the invention is directed towards the use of the compositions of the invention in the production of a film or sheet.

In a further aspect, the present invention provides a method for producing a film or sheet comprising the step of mixing the biopolyester masterbatch of the present invention with biopolyester resin

In yet a further aspect, the invention is directed toward the use of inorganic antiblock is sodium calcium aluminosilicate hydrate with slip additive wherein the slip additive is selected from the group consisting of polyol partial ester; fully hydrogenated soybean oil; ester with pentaerythritol; N,N′-Ethylene Bis(Stearamide) to provide low Dynamic COF and good transparency.

Features and advantages of the composition of the present invention will be further explained with reference to the embodiments and the examples showing unexpected results.

### EMBODIMENTS OF THE INVENTION

Biopolyester

Biopolyesters are polyesters whose monomeric sources are at least partially derived from biologically renewable resources or polyesters which have the properties to be biodegradable. For example: PLA is a particular biopolyester which has both properties. PLA is a well-known biopolyester, having the following monomeric repeating group:

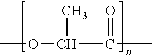

The PLA can be either poly-D-lactide, poly-L-lactide, or a combination of both. Preferably, the PLA is a crystalline polylactic acid homopolymer of about 90-100 wt % L-lactic acid units (or 0-10 wt % D-lactic acid units).

PLA is available from multiple suppliers and the polymers and/or polymer blends of the instant invention are not limited to any one grade or supplier thereof. PLA is available from, for example, NatureWorks LLC, Minnetonka, Minn., U.S.A. in the Ingeo product line for the 2000 and 4000 series, which can be used in film processing and includes certain grades designed for processing into biaxially oriented films.

Within the Ingeo 4000 series, the PLA grades have a molecular weight average of 200,000 to about 400,000, and comprise a mesolactide level of about 10 percent to about 20 percent, and a moisture level lower than about 500 ppm. The grades 4060D, 4042D, 4043D and 4032D, 4033D may be used for PLA films. Preferred for the present invention are 4042D and 4043D, which have 4-5% D lactide; however, the average molecular weight of PLA can be any which is currently available in a commercial grade or one which is brought to market in the future.

In the case of a sealable skin layer, the preferred grade of this invention will be the Ingeo 4060D grade with the use of another slip agent than N,N′-Ethylene Bis(Stearamide) (EBS) to avoid any change of the PLA morphology and crystallinity and so avoid effect on the sealing properties by increasing the sealing temperature.

“Biopolyester(s) means that one or more biopolyesters can be used in the invention.

Inorganic Antiblock Additive

Inorganic antiblock additives are used to reduce adhesion between polymer films by changing the surface topography of the film to create varying levels of roughness. Inorganic antiblocks additives include, for example, natural and synthetic silica (silicon dioxide, SiO₂), talc (magnesium silicate), calcium carbonate (CaCO₃), ceramic spheres (alumina-silicate ceramic), kaolin/clay (aluminum silicate), and mica (aluminum potassium silicate).

Sodium calcium aluminosilicate hydrate (also referred to herein as the “silicate”) is the preferred inorganic antiblock additive in the present invention.

The silicate of the present invention is between 2 and 10 microns mean particle size, and is preferably between 3 to 5 microns mean particle size. The concentration of silicate is preferably minimized to avoid introducing haze to the film.

Examples of the commercially available silicates are Silton JC-30, Silton JC-40, Silton JC-50 and Silton JC-70, manufactured by Mizusawa Industrial Chemicals, Co., Ltd.; and Sylosphere, manufactured by Fuji Sylisia.

Slip Additives

Slip additives act similarly to antiblock additives in that they both serve to lower the Dynamic COF between two overlapping films. Slip additives are modifiers that act as an internal lubricant. The slip additive migrates (i.e. “blooms”) to the surface of the polymer, creating a surface coating. This surface coating is a microscopic lubricant layer that provides an enhanced lubricity and slip characteristic to the film. Excessive amounts of slip additive, however, may produce films that are excessively smooth, which can compromise the ability of substances (e.g., ink, stickers, etc.) to adhere to the surface.

Typical slip additives are, for example, oleamide, erucamide, stearamide, behenamide, oleyl palmitamide, stearyl erucamide, ethylene bis-oleamide, N,N′-Ethylene Bis(Stearamide) (EBS), including most grades of their respective refinement. In one embodiment of the present invention, EBS is used as a slip additive in the biopolyester composition. EBS is sold under the trade names Acrawax C, Finawax C, Crodamide EBS, among others. In another embodiment, polyol partial esters; fully hydrogenated soybean oil; and ester with pentaerythritol are used as a slip additive in the biopolyester composition. Loxiol® P728, an ester wax additive produced by Cognis GmbH, for example, is a commercially available polyol partial ester. Loxiol® P861/3.5, a thermoresistant ester produced by Cognis GmbH, for example, is a commercially available fatty acid ester with pentaerythritol. Pationic® 919, a lubricant produced by Caravan Ingredients, for example, is a commercially available fully hydrogenated soybean oil known as glycerol tri strearate.

Masterbatches

Because the antiblock and slip additives of the present invention are used in small quantities, they can be prepared, separately or together, in a masterbatch formulation, in which an “inactive” carrier resin is used to deliver and disperse these minor amounts of additives into the overall composition. There can be one masterbatch for each additive or, preferably, one masterbatch for more than one additive.

Optional Additives

The compound of the present invention can include conventional plastics additives in an amount that is sufficient to obtain a desired processing or performance property for the compound. The amount should not be wasteful of the additive or detrimental to the processing of the biopolyester film or performance of the composition or film. Those skilled in the art of thermoplastics compounding, without undue experimentation but with reference to such treatises as Plastics Additives Database (2004) from Plastics Design Library (www.williamandrew.com), can select from many different types of additives for inclusion into the compounds of the present invention.

Non-limiting examples of optional additives include adhesion promoters; biocides (antibacterials, fungicides, and mildewcides), anti-fogging agents; bonding, blowing and foaming agents; dispersants; fillers and extenders; fire and flame retardants and smoke suppresants; impact modifiers; initiators; lubricants; micas; pigments, colorants and dyes; plasticizers; processing aids; release agents; silanes, titanates and zirconates; slip and anti-blocking agents; stabilizers; stearates; ultraviolet light absorbers; viscosity regulators; waxes; and combinations of them.

Table 1 shows acceptable, desirable and preferable ranges of ingredients useful in the present invention, all expressed in weight percent (wt. %) of the entire compound. The composition of the invention can comprise, consist essentially of, or consist of these ingredients in these amounts.

TABLE 1

| | Acceptable | Desirable | Preferable |
|---|---|---|---|
| Bipolyester | 40-99.98 | 76.5-99.8 | 93.1-99.35 |
| Inorganic antiblock additive | 0.01-5 | 0.1-1 | 0.15-0.4 |
| Slip additive | 0.01-5 | 0.1-2.5 | 0.5-1.5 |
| Other optional additives | 0-50 | 0-20 | 0-5 |

Processing

The preparation of compositions of the present invention is uncomplicated. The composition of the present invention can be made in continuous operations.

Mixing in a continuous process typically occurs in an extruder that is elevated to a temperature that is sufficient to melt the polymer matrix with addition either at the head of the extruder or downstream in the extruder of the solid ingredient additives. Specific melt mixing equipments suitable for the manufacture of the said masterbatch include single screw extruder, co-rotating or counter-rotating twin screw extruder, multiple screw extruder or co-kneader. Preferably the melt mixing equipment used is a twin screw co-rotating extruder equipped with screws having a length to diameter (L/D) ratio of at least 40. Typically, the output from the extruder is pelletized into standard pellets, or may also be cut by an underwater pelletizer to create beads. The pellets or beads are used for later extrusion or molding into polymeric articles.

If the polymer is available under powder form it is possible to incorporate a physical and homogeneous blend polymer and additives by the main hopper. To ensure constant and homogeneous quality of the masterbatch, the ingredients are preferably dosed in a twin screw extruder with gravimetric dosing units. Preferentially the polymer carrier is added in the extruder via the main hopper and the antiblock or slip or blend of both is incorporated into the polymer via a side feeder.

Processing conditions to be applied during masterbatch are dependent of the polymer carrier used. In the preferred case where the polymeric carrier is PLA, then the processing temperature are in the range of 180 to 240° C. Masterbatch concentrates that can be later letdown into the PLA resin to produce the compositions of the present invention.

Subsequent extrusion or molding techniques to form polymer films are well known to those skilled in the art of thermoplastics polymer engineering. Without undue experimentation but with such references as “Extrusion, The Definitive Processing Guide and Handbook” published by Plastics Design Library (www.williamandrew.com), one can use different techniques for making films using the composition of the present invention.

Biopolyester films may be formed, for example, from an extruded melt that is blown or cast or even cast and quenched, either onto a drum, a belt, in water, or the like. The cast film may be subsequently oriented, either uniaxially or biaxially, using conventional equipment such as drawing on heated rollers or using a tenter-frame, or a combination thereof. The processing operation may also include crystallization (of the outer layers) and/or heat-setting of the film.

### Usefulness of the Invention

The present invention may be used in numerous applications films and sheets that could benefit from a polymer film or sheet that incorporates materials that are both from renewable resources, and which are compostable. Such films and sheet may be in the form of a web, film, sheet, laminate, or the like, whether coextruded, extrusion laminated, extrusion coated, conventionally laminated, or otherwise produced by any other process.

Specifically the present invention may be desirable for polymer films and sheet used in food, consumer, agricultural, medical and personal care packaging. Food packaging applications include pouches, packaging bags, packaging rolls, sheets, trays, carton liners, and wrappers. Examples of non-food film applications are leaf and yard waste bags, agricultural films, can liners, construction materials, medical applications (e.g. sterile wraps, IV bags, biomedical waste bags) and consumer products, such as trash bags and diaper liners.

Products employing polymer films that may particularly benefit from also having greater transparency include screen printing films, lamination film, labels, adhesives, stretch and shrink wraps, and photographic materials.

### Examples

Table 2 shows the list of ingredients, their purpose, and their commercial sources. Table 3 shows the recipes for the masterbatches, Examples 1-9, and their methods of preparation. Table 4 shows the recipes for the films of Comparative Examples A-P and Examples 8-13. Table 5 presents the test results of the Comparative Examples and Examples of the PLA compositions.

These tests demonstrated that only six recipes of 22, including the control, achieve a coefficient of friction of 0.35 or less and a haze of less than 2 percent or less. Those six recipes, Examples 8-13, used sodium calcium aluminosilicate hydrate as an antiblock additive and either N,N′-Ethylene Bis (Stearamide) or polyol partial ester or fully hydrogenated soybean oil or ester with pentaerythritol as the slip additive. The other recipes, Comparative Examples A-P were unacceptable because of excessive coefficient of friction, excessive haze, or both.

TABLE 2

| Brand Name | Ingredient and Purpose | Commercial Source |
|---|---|---|
| PLA 4042D | Carrier and/or Primary Resin | NatureWorks LLC |
| | (Polylactic acid) | |
| Loxiol P728 | Slip additive | Cognis GmbH |
| | (ester wax additive) | |
| Erucamide | Slip additive | Croda |
| | (stearyl erucamide) | |
| EBS | Slip additive | Croda |
| | (N,N'-Ethylene Bis | |
| | (Stearamide), EBS) | |
| Epostar MA | Antiblock | Nippon Shokubai |
| 1004 | (poly (methyl methacrylate) | |
| | (PMMA)) | |
| Sylobloc 45H | Antiblock | W.R. Grace & Co . |
| | (amorphous silicon dioxide) | |
| Silton JC 50 | Antiblock | Mizusawa Industrial |
| | (Sodium calcium | Chemicals |
| | aluminosilicate hydrate) | |
| Silton JC 70 | Antiblock | Mizusawa Industrial |
| | (Sodium calcium | Chemicals |
| | aluminosilicate hydrate) | |
| Loxiol ® P861/3.5 | Slip additive | Cognis GmbH |
| | (long chain ester of | |
| | pentaerythritol) | |
| Pationic ® 919 | Slip additive | Caravan Ingredients |
| | (glycerol tri stearate) | |

The compositions for all Examples were made using the masterbatches shown in Table 3. These masterbatch concentrates were prepared by a continuous process that mixed one or more additives into a carrier resin, most often the same resin that the masterbatch concentrates would later be let down into the PLA composition. The processing conditions for the masterbatches are provided in Table 3, for a ZSK twin-screw extruder.

TABLE 3

| Masterbatch | 1 | 2 | 3 | 4 | 5 | 6 | 7 | 8 | | 9 | |
|---|---|---|---|---|---|---|---|---|---|---|---|
| Additive in PLA | 5% | 5% Silton | 5% Silton | 5% Epostar | 10% | 10% EBS | 10% | 10% Loxiol ® | | 10% | |
| 4042D | Sylobloc | JC 50 | JC 70 | 1004 | Loxiol | | Erucamide | P861/3.5 | | Pationic ® | |
| | 45H | | | | P728 | | | | | 919 | |
| Purpose | Antiblock | Antiblock | Antiblock | Antiblock | Slip | Slip | Slip | slip | | slip | |
| Throughput main | 12.65 | 25 | 25 | 14.25 | 13.5 | 13.5 | 13.5 | 10 | Kg/h | 10 | Kg/h |
| feeder (kg/h) | | | | | | | | | | | |
| Throughput side | 2.35 | 0 | 0 | 0.75 | 1.5 | 1.5 | 1.5 | — | | — | |
| feeder (kg/h) | | | | | | | | | | | |
| Throughput (kg/h) | 15 | 25 | 25 | 20 | 15 | 15 | 15 | 10 | Kg/h | 10 | Kg/h |
| Screw speed (rpm) | 500 | 500 | 500 | 450 | 750 | 750 | 750 | 400 | rpm | 400 | rpm |

| | | | | | | | | | |
|---|---|---|---|---|---|---|---|---|---|
| Temperature 1 (° C.) | | | | | | | | — | — |
| (non heated) | | | | | | | | | |
| Temperature 2 (° C.) | 200 | 180 | 180 | 108 | 106 | 100 | 106 | 100° C. | 100° C. |
| Temperature 3 (° C.) | 220 | 180 | 180 | 220 | 200 | 200 | 200 | 160° C. | 160° C. |
| Temperature 4 (° C.) | 220 | 180 | 180 | 220 | 200 | 200 | 200 | 200° C. | 200° C. |
| Temperature 5 (° C.) | 220 | 180 | 180 | 220 | 200 | 200 | 200 | 200° C. | 200° C. |
| Temperature 6 (° C.) | 220 | 180 | 180 | 220 | 200 | 200 | 200 | 200° C. | 200° C. |
| Temperature 7 (° C.) | 220 | 180 | 180 | 220 | 200 | 200 | 200 | 210° C. | 210° C. |
| Temperature 8 (° C.) | 220 | 180 | 180 | 220 | 200 | 200 | 200 | 210° C. | 210° C. |
| Temperature 9 (° C.) | | | | | | | | | |
| (non heated) | | | | | | | | | |
| Temperature 10 (° C.) | 220 | 180 | 180 | 220 | 200 | 200 | 200 | 210° C. | 210° C. |
| Temperature 11 (° C.) | 220 | 180 | 180 | 220 | 200 | 200 | 200 | 210° C. | 210° C. |
| Temperature 12 (° C.) | 220 | 180 | 180 | 220 | 200 | 200 | 200 | 210° C. | 210° C. |

Films of the PLA compositions of Comparative Examples A-P and Examples 8-13 were produced on a LMCR-300 Multilayer Cast Film Line manufactured by Labtech Engineering Company Ltd. Two of the three single screw extruders (1-type LE 20-30, and 1-type LE 25-30) of the system were used to process the films having a 20 micron middle layer and two 5 micron layer skin or surface layers.

The PLA for the middle layer was extruded in the main extruder at melt temperatures in the first two zones set at 230° C. and the latter four zones set at 220° C. operating at 111 bars of pressure and 54 amperes and 45 rpm screw speed. The material in that extruder had a temperature of about 215° C.

The PLA compositions of the Examples and Comparative Examples for the skin layers were extruded in one of the two side extruders at melt temperatures in the first two zones set also at 230° C. and the latter two zones set also at 220° C. operating at 90 bars of pressure and 58 amperes and a 44 rpm screw speed. The material in that extruder had a temperature of about 211° C.

The central block was heated at 220° C. and the die at 225° C. on the borders and 215° C. in the middle. The molten material from the main extruder emerged from the middle of a three orifice ‘coat hanger’ die at the same time that the molten material from the side extruder emerged from two flanking orifices. These layers were pressed into a three-layer film through the die and then quenched on a chill roll at 40° C. operating at a speed of 10 m/min.

TABLE 4
Recipes (Weight Percent)

| | A | B | C | D | E | F | G | H | I | J | K | L |
|---|---|---|---|---|---|---|---|---|---|---|---|---|
| PLA 4042D | 100 | 95 | 95 | 95 | 96 | 96 | 96 | 96 | 86 | 86 | 86 | 81 |
| Masterbatch 1 | | | | | | 4 | | | | | | |
| 5% Sylobloc 45H Antiblock | | | | | | | | | | | | |
| Masterbatch 2 | | | | | | | 4 | | | | | |
| 5% Silton JC 50 Antiblock | | | | | | | | | | | | |
| Masterbatch 3 | | | | | | | | 4 | | | | |
| 5% Silton JC 70 Antiblock | | | | | | | | | | | | |
| Masterbatch 4 | | | | | 4 | | | | 4 | 4 | 4 | 4 |
| 5% Epostar 1004 Antiblock | | | | | | | | | | | | |
| Masterbatch 5 | | 5 | | | | | | | 10 | | | 15 |
| 10% Loxiol P728 Slip | | | | | | | | | | | | |
| Masterbatch 6 | | | | 5 | | | | | | | 10 | |
| 10% EBS Slip | | | | | | | | | | | | |
| Masterbatch 7 | | | 5 | | | | | | | 10 | | |
| 10% Erucamide Slip | | | | | | | | | | | | |

| | | | | | | | | | | | | |
|---|---|---|---|---|---|---|---|---|---|---|---|---|
| Total | 100 | 100 | 100 | 100 | 100 | 100 | 100 | 100 | 100 | 100 | 100 | 100 |

| | | | | | | | | | |
|---|---|---|---|---|---|---|---|---|---|
| M | N | 8 | O | 9 | 10 | P | 11 | 12 | 13 |

| | | | | | | | | | | |
|---|---|---|---|---|---|---|---|---|---|---|
| PLA 4042D | 81 | 81 | 86 | 86 | 86 | 81 | 81 | 81 | 86 | 86 |
| Masterbatch 1 | | | | | | | | | | |
| 5% Sylobloc 45H Antiblock | | | | | | | | | | |
| Masterbatch 2 | | | 4 | 4 | 4 | 4 | 4 | 4 | 4 | 4 |
| 5% Silton JC 50 Antiblock | | | | | | | | | | |
| Masterbatch 3 | | | | | | | | | | |
| 5% Silton JC 70 Antiblock | | | | | | | | | | |
| Masterbatch 4 | 4 | 4 | | | | | | | | |
| 5% Epostar 1004 Antiblock | | | | | | | | | | |
| Masterbatch 5 | | | 10 | | | 15 | | | | |
| 10% Loxiol P728 Slip | | | | | | | | | | |
| Masterbatch 6 | | 15 | | | 10 | | | 15 | | |
| 10% EBS Slip | | | | | | | | | | |
| Masterbatch 7 | 15 | | | 10 | | | 15 | | | |
| 10% Erucamide Slip | | | | | | | | | | |
| Masterbatch 8 | | | | | | | | | 10 | |
| Loxiol ® P861/3.5 | | | | | | | | | | |
| Masterbatch 9 | | | | | | | | | | 10 |
| Pationic ® 919 | | | | | | | | | | |
| Total | 100 | 100 | 100 | 100 | 100 | 100 | 100 | 100 | 100 | 100 |

TABLE 5
Test Results

| Testing Method | | A | B | C | D | E | F | G | H | I | J |
|---|---|---|---|---|---|---|---|---|---|---|---|
| COF Static Average | ASTM | NC* | NC | NC | NC | 0.472 | 0.411 | 0.485 | 0.549 | 0.100 | 0.416 |
| Value | D1894-01 | | | | | | | | | | |
| Internal Side | | | | | | | | | | | |
| COF Dynamic Average | ASTM | NC | NC | NC | NC | 0.532 | 0.549 | 0.532 | 0.569 | 0.089 | 0.487 |
| Value | D1894-01 | | | | | | | | | | |
| Internal Side** | | | | | | | | | | | |
| COF Static Average | ASTM | NC | NC | NC | NC | 0.461 | 0.455 | 0.474 | 0.429 | 0.176 | 0.362 |
| Value | D1894-01 | | | | | | | | | | |
| External Side | | | | | | | | | | | |
| COF Dynamic Average | ASTM | NC | NC | NC | NC | 0.540 | 0.533 | 0.528 | 0.576 | 0.160 | 0.446 |
| Value | D1894-01 | | | | | | | | | | |
| External Side** | | | | | | | | | | | |
| Haze | ASTM | 0.32% | 0.37% | 0.29% | 0.34% | 2.42% | 4.02% | 1.75% | 1.85% | 2.61% | 2.31% |
| | D1003 | | | | | | | | | | |

| Testing Method | | K | L | M | N | 8 | O | 9 | 10 | P | 11 |
|---|---|---|---|---|---|---|---|---|---|---|---|
| COF Static Average | ASTM | 0.160 | 0.059 | 0.380 | 0.100 | 0.083 | 0.468 | 0.187 | 0.058 | 0.447 | 0.075 |
| Value | D1894-01 | | | | | | | | | | |
| Internal Side | | | | | | | | | | | |
| COF Dynamic | ASTM | 0.197 | 0.057 | 0.462 | 0.122 | 0.080 | 0.487 | 0.213 | 0.068 | 0.484 | 0.067 |
| Average Value | D1894-01 | | | | | | | | | | |
| Internal Side** | | | | | | | | | | | |
| COF Static Average | ASTM | 0.162 | 0.066 | 0.329 | 0.125 | 0.097 | 0.365 | 0.161 | 0.080 | 0.349 | 0.087 |
| Value | D1894-01 | | | | | | | | | | |
| External Side | | | | | | | | | | | |
| COF Dynamic | ASTM | 0.202 | 0.058 | 0.408 | 0.133 | 0.095 | 0.395 | 0.193 | 0.094 | 0.370 | 0.095 |
| Average Value | D1894-01 | | | | | | | | | | |
| External Side** | | | | | | | | | | | |
| Haze | ASTM | 2.85% | 2.26% | 2.62% | 2.56% | 1.40% | 1.32% | 1.45% | 1.28% | 1.27% | 1.42% |
| | D1003 | | | | | | | | | | |

| Testing Method | | 12 | 13 |
|---|---|---|---|
| COF Static Average | ASTM | 0.091 | 0.075 |
| Value | D1894-01 | | |
| Internal Side | | | |
| COF Dynamic Average | ASTM | 0.077 | 0.103 |
| Value | D1894-01 | | |
| Internal Side** | | | |
| COF Static Average | ASTM | 0.087 | 0.074 |
| Value | D1894-01 | | |
| External Side | | | |
| COF Dynamic Average | ASTM | 0.093 | 0.099 |
| Value | D1894-01 | | |
| External Side** | | | |
| Haze (%) | ASTM | 1.76 | 1.62 |
| | D1003 | | |

*NC = Too High to be Measured
**Both the Internal Side and the External Side of the Dynamic COF were taken into consideration.

COF and Haze values were measured for the films produced by the cast film extrusion line. Table 5 shows the COF values measured using the ASTM D1894 Standard Test Method for Static and Kinetic Coefficients of Friction of Plastic Film and Sheeting and the haze values measured using the ASTM D1003 Standard Test Method for Haze and Luminous Transmittance of Transparent Plastics for the Comparative Examples and Examples.

For this invention the Dynamic COF values were used to determine acceptable properties, both considering the Internal Side and the External Side.

The Control, Comparative Example A, which is only polylactic acid (PLA 4042), demonstrated a low haze value, but had COF values which were so high they could not be measured by the instrumentation.

Comparative Examples B-D tried three different slip additives without any antiblock additives. The COF was too high to be measured.

Comparative Examples E-H tried four different antiblock additives without any slip additives. The Dynamic COF values were too high.

Comparative Examples I-N tried the Epostar antiblock additives with the three different slip additives in varying amounts. Comparative Examples I, K, L, and N had acceptable Dynamic COF values but unacceptable haze values. Comparative Examples J and M had unacceptable Dynamic COF and haze values.

Examples 8 and 10 tried the Silton JC 50 antiblock additive with the Loxiol P728 slip additive, in different amounts. Examples 9 and 11 tried the same antiblock additive with the EBS slip additive. Examples 12 and 13 tried the same antiblock additive with Loxiol® P861/3.5 and Pationic® 919 slip additives. All for Examples 8-13 had both acceptable Dynamic COF values and acceptable haze values.

Comparative Examples O and P tried the same antiblock additive with erucamide slip additive. While haze values were acceptable, Dynamic COF values were not.

Thus, Examples 8-13, which employed a combination of a sodium calcium aluminosilicate hydrate as the antiblock additive and either EBS or polyol partial esters or fully hydrogenated soybean oil or ester with pentaerythritol as the slip additive, demonstrated acceptable COF and haze values for the PLA films of the invention. This result is unexpected, because the additives individually added to the PLA resins resulted in films with COF values that were too high, specifically Comparative Examples G and H using sodium calcium aluminosilicate hydrate and PLA resin, and specifically Comparative Examples B and D using either EBS or polyol partial esters, and PLA resin.

Therefore, there was needed and unexpectedly found a specific combination of antiblock additive and slip additives in order to obtain acceptable low COF and acceptable low haze values for the PLA compositions: sodium calcium aluminosilicate hydrate as the antiblock additive and either EBS or polyol partial ester or fully hydrogenated soybean oil or ester with pentaerythritol as the slip additive.

The invention is not limited to the above embodiments. The claims follow.

What is claimed is:

1. A composition for a biopolyester film, comprising:
(a) biopolyester(s);
(b) inorganic antiblock additive;
(c) slip additive; and
(d) optionally, other additives;
wherein the inorganic antiblock additive is sodium calcium aluminosilicate hydrate,
wherein the slip additive is selected from the group consisting of polyol partial ester, N,N′-Ethylene Bis(Stearamide), fully hydrogenated soybean oil, ester with pentaerythritol and combinations thereof, and
wherein the composition when in the form of a 30 micron film having a core layer of about 20 microns and two skin layers of about 5 microns has both a Dynamic COF of less than 0.35 when measured according to ASTM D1894-01 and a haze value of less than two percent when measured according to ASTM D1003.

2. The composition of claim 1, wherein the biopolyester is polylactic acid and wherein the Dynamic COF is less than 0.2.

3. The composition of claim 1, further comprising optional additives selected from the group consisting of adhesion promoters; biocides; anti-fogging agents; bonding, blowing and foaming agents; dispersants; initiators; lubricants; pigments, colorants and dyes; plasticizers; processing aids; release agents; stabilizers; stearates; ultraviolet light absorbers; viscosity regulators; waxes; and combinations of them.

4. The composition of claim 2, wherein the ingredients by weight percent (wt. %) of the entire composition are listed in the chart below.

| | |
|---|---|
| Polylactic acid | 40-99.98 |
| Inorganic antiblock additive | 0.01-5 |
| Slip additive | 0.01-5 |
| Other optional additives | 0-50. |

5. The composition of claim 2, wherein the polylactic acid substantially comprises L-lactic acid units.

6. A film produced from the composition of claim 1, wherein the film has at least one layer, and each layer may comprise a different combination of ingredients.

7. The film of claim 6, wherein there is a skin layer and a core layer; and wherein the skin layer is between about 0.5 microns to about 1 millimeter.

8. The film of claim 7, wherein the film forming two skin layers of about 5 microns each sandwiching a core layer of biopolyester resin with a thickness of about 20 microns will result in a haze of 2 percent or less according to the ASTM D1003 method and a dynamic coefficient of friction of 0.35 or less according to the ASTM D1894-01 method.

9. The film of claim 6, wherein the film is biaxially-oriented.

10. The film of claim 8, wherein the dynamic coefficient of friction is less than 0.20.
